(19) United States
(12) Patent Application Publication
(10) Pub. No.: US 2017/0204446 A1
(43) Pub. Date: Jul. 20, 2017

(54) System for rapid continuous manufacturing of monoclonal antibodies

(71) Applicants: MAURIZIO VICTOR CATTANEO, Boston, MA (US); MARK HENRY KAMGA, Malden, MA (US); REMCO ALEXANDER SPANJAARD, Brookline, MA (US)

(72) Inventors: MAURIZIO VICTOR CATTANEO, Boston, MA (US); MARK HENRY KAMGA, Malden, MA (US); REMCO ALEXANDER SPANJAARD, Brookline, MA (US)

(73) Assignee: Artemis BioSystems Inc., Cambridge, MA (US)

(21) Appl. No.: 14/996,226

(22) Filed: Jan. 15, 2016

(51) Int. Cl. C12P 21/00; B01D 15/42; B01D 15/14; B01D 15/38

(52) U.S. Cl. CPC C12P 21/005; B01D 15/3809; B01D 15/42; B01D 15/14

(57) ABSTRACT

Described herein is a rapid continuous biomanufacturing platform process that combines a perfusion mammalian cell culture with a synchronized purification of the antibodies produced by the cell culture without the use of intermediate media holding tanks or other large retention devices. This method described herein includes continuous cell culture of mammalian cells expressing the biological of interest and comprising a cell retention device wherein the perfusion of fresh media into the reactor and hence the harvest rate of antibody containing spent media from the reactor has a rate of 1 vessel volume per day (vvd) or less obtained by glucose control with a cell density of between 40 million cell/ml and 60 million cell/nil. Immediate recovery and purification of the antibody is obtained by synchronizing the rate of perfusion with the antibody capture and elution step cycle in a column that contains affinity resin that is between 0.01 and 0.001 times the volume of the bioreactor. The perfusion rate and capture rate were perfectly synchronized by extensive method and media development resulting in equal rates and eliminating the need for holding tanks and cell bleeding. The result is an order of magnitude faster antibody production as compared to conventional fed-batch mode.

### BACKGROUND OF THE INVENTION

Field of the Invention

The present invention relates to a novel, rapid, flexible and cost effective “low flow” continuous bioprocess for producing monoclonal antibodies or other biological of interest in mammalian cell culture. The cell culture strategy described herein is based on the ability to combine perfusion cell culture at low perfusion rates of one vessel volume per day or less and high cell densities (40.times.10.sup.6 cells/mL or higher) without bleeding the cell culture through metabolic control with continuous affinity purification by synchronizing the perfusion flow with the rate of antibody capture by the affinity chromatography column thus allowing rapid production of monoclonal antibodies or other biologicals of interest including viral vectors and subunit vaccines and smaller upstream and downstream equipment and reduced amount of affinity matrix material.

Description of the Related Art

Traditionally, perfusion cell culture has been operated using high media volumes and bleeding the cells to maintain a high cell density around 80.times.10.sup.6 cells/ml. This method utilizes high perfusion rates of 2 vessel volumes per day (vvd) or (much) higher to maintain a high cell viability. When cell densities exceed 80.times.10.sup.6 cells/ml, cell bleeding is normally employed to reduce cell aggregation (Crowley et al., 2016 U.S. Pat. No. 9,260,695). Cell aggregation causes control problems since the cell aggregate does not behave as a single cell in suspension mode. A cell aggregate may cause a reduction in cell viability as a result of diffusion limitations of oxygen and nutrients and accumulation of toxic metabolites inside the cell aggregate. By performing regular cell bleeding cell aggregation is reduced with a concomitant increase in cell viability.

The current art is to collect spent media containing the protein (e.g., antibody) of interest derived from cells (e.g., CHO, Per.C6 and HEK) that are cultured in large steel vats (10,000 L or more) and to purify the secreted protein using large columns (e.g., packed with protein A designed to minimize capture time). This method requires large diameter capture chromatography columns (1.5 m diameter columns containing 300 L or more of affinity resin) to minimize the time and maximize the efficiency of the chromatographic step.

Moreover, current knowledge employing continuous capture chromatography uses multiple columns and complex non-commercial equipment such as multiple valves and switching between columns steps.

Continuous purification has been implemented in other industries for over fifty years, starting with a two dozen columns continuous purification of xylenes in the sixties (Parsons et al. 1961). In the pharmaceutical industry, however, continuous purification was pioneered by the simulated moving bed technology using six columns and has progressed to the twin column system by ChromaCon®. FIG. 1 summarizes a few examples on the evolution of continuous purification.

Recent work in the area has proposed integrated systems consisting of a continuous upstream coupled with a multi-column continuous downstream process. Examples of these include the simulated moving bed (SMB) with four to six columns (Keβler et al. 2007; Seidel-Morgenstern et al. 2008), sequential multicolumn chromatography (SMCC) with four columns (Ng et al. 2014; Girard et al. 2015), periodic counter-current chromatography (PCC) with 3 columns (Warikoo et al. 2012; Konstantinov and Cooney 2015) and the twin column chromatography with two columns (Angarita et al. 2015).

The multi-column approach is linked to the higher perfusion rates of three to five reactor volumes per day (Warikoo et al. 2012). By performing innovative media formulations, the current approach has been optimized to one reactor volume/day while keeping nutrient and wastes under control. This alone represents a multi-fold reduction in media use. This cost savings upstream is equally transferred downstream because a smaller volume of material with higher concentration of antibody is produced, enabling the use of one column.

In this work, the first successful integrated continuous biomanufacturing comprising of a perfusion culture coupled with an OCC for the production of therapeutic antibodies with consistent product quality is presented. By performing process and media optimization strategies, the rate of perfusion was matched to the purification rate. The key improvements in our process over recent attempts are: improved perfusion parameters to reduce media use (a significant driver of cost in cell culture), production of higher antibody concentration perfusate because of lower perfusion rates, optimization of resin dynamic binding capacity by low flow rates, eventually resulting in a twenty fold reduction in Protein A use. Moreover, the use of a single column downstream capture step is technically very practical and can be easily implemented across companies with diverse plant and equipment features better than technologies such as SMB, SMCC and PCC.

### SUMMARY OF THE INVENTION

In this present invention, a perfusion bioreactor producing a monoclonal antibody or other biological of interest by continuous low-flow perfusion volume (1 vessel volume per day (vvd) or less), is connected to a single, relatively small affinity column for continuous capture of the biological of interest.

The present invention discloses a process for the culturing of cells by perfusion culturing of a cell culture comprising cell culture medium and cells, wherein cell culture medium is added to the cell culture, wherein the cell culture is circulated over a filter module comprising hollow fibers wherein the flow within the filter module is an alternating tangential flow and the perfusate from the hollow fibers is introduced directly into a separation unit such as a chromatography column such that the entire system consisting of perfusion bioreactor and chromatography unit work in continuous fashion without flow interruptions.

It has surprisingly been found that by perfusion culturing of mammalian cells according to the invention, an optimal range viable cell densities can be obtained using low perfusion flow under metabolic control, whereas the cell culture further displays an extremely high cell viability. Furthermore, it was found that the perfusion process of the invention leads to a high viable cell concentration without the use of cell bleeding. This is a surprising finding because perfusion cell culturing, typically requires bleeding of cells to maintain a high cell viability. A high cell viability during perfusion cell culturing is crucial, because the health of the cells determines their longevity and continued cell productivity over an extended period of time as in continuous bioprocessing. The low perfusion flow has the added benefit of reducing consumption of media which is a major component of the cost of goods for running the perfusion operation thus making perfusion a viable process operation. In addition, the low perfusion rates are beneficial to the downstream purification step as it permits the operation of a one-column continuous chromatography system as explained below.

A perfusion process is described in U.S. Pat. No. 6,544,424. Although this document mentions that this process may be used for perfusion culturing of animal cells, it does neither disclose nor suggest the metabolic control used to maintain a low flow perfusion flow concentration found in the present invention.

It has long been recognized that a continuous process integrating perfusion and downstream capture chromatography offers better economics compared to batch processes of culturing cells. In this operation, cells are retained in the bioreactor, and the product is continuously removed along with toxic metabolic byproducts. Feed, containing nutrients is continually added. This operation is capable of achieving high cell densities and more importantly, the cells can be maintained in a highly productive state for weeks. This achieves much higher yields and reduces the size of the bioreactor necessary. It is also a useful technique for cultivating primary or other slow growing cells. Perfusion operations have tremendous potential for growing the large number of cells needed for human cell and genetic therapy applications.

One of the most important factors in continuous chromatography is monitoring performance of chromatography columns and making column switching decisions. In SMB and PCC, there are multiple columns, each requiring continuous monitoring. Even with the use of multivariate statistics, this becomes very cumbersome. The current approach is to rely on cycle number provided by the manufacturer which might be unreliable. In OCC, the use of a single column ensures the development of a detailed column monitoring regime, providing detailed information on column performance and life cycle and ensuring accurate column switching decisions are made. In addition this continuous platform is enabling the use of smaller affinity capture columns (10-20 times smaller compared to fed-batch operations) thus reducing the requirement for expensive affinity media. The antibody purification rate is synchronized with the perfusion antibody production rate by maintaining viable cell densities ranging from 50 million cells per mL and 60 million cells per mL and controlling the perfusion rate to 1 vvd or less and by controlling the glucose level in the bioreactor between 0 and 3 g/L, preferably around 1 g/L and maintaining the lactate level below 3 g/L.

In order to reduce the volume of resin, extensive process optimization was performed to ensure optimum residence times for the maximum amount of loading while ensuring required washing, eluting and re-equilibration of the column. The time for the entire optimized cycle was computed and the perfusion rate was adjusted to match this rate.

However, the optimum perfusion did not meet bioreactor nutrient replenishment requirements and metabolite removal so to keep the perfusion rates at this optimum values, media optimization was performed by balancing glucose levels to keep glucose between 1-3 g/L and lactate below 3 g/L. By making these careful adjustments, the perfusion rate was optimized to a level that permitted spent media production and antibody concentrations at levels that could be efficiently handled by a column that is 0.1-5% the volume of material in the bioreactor.

### DESCRIPTION OF THE FIGURES

FIG. 1 shows a schematic of the continuous manufacturing system for production of monoclonal antibodies, recombinant proteins or viral vectors.

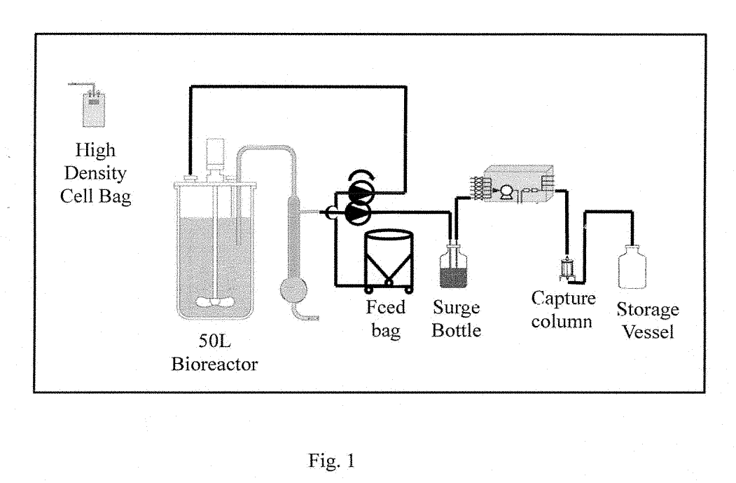

FIG. 2A shows nutrient and waste control of the bioreactor CHO cell culture using glucose/lactate monitoring.

FIG. 2B shows viable cell density and titers of produced monoclonal antibodies during continuous cell culture of CHO cells over a period of 34 days.

FIG. 3 shows CHO cell growth profile and the effects of perfusion rate on viable cell density (VCD) and viability. The perfusion rate was set at 0.5 vvd until day 14 then increased to 1 vvd. Glucose was added at day 7 and day 10 to increase the viable cell density in the perfusion bioreactor.

FIG. 4 shows the relationship between Protein A dynamic binding capacity of (monoclonal) antibodies and linear flow.

FIG. 5 shows consecutive purification cycles during OCC showing duration of individual steps.

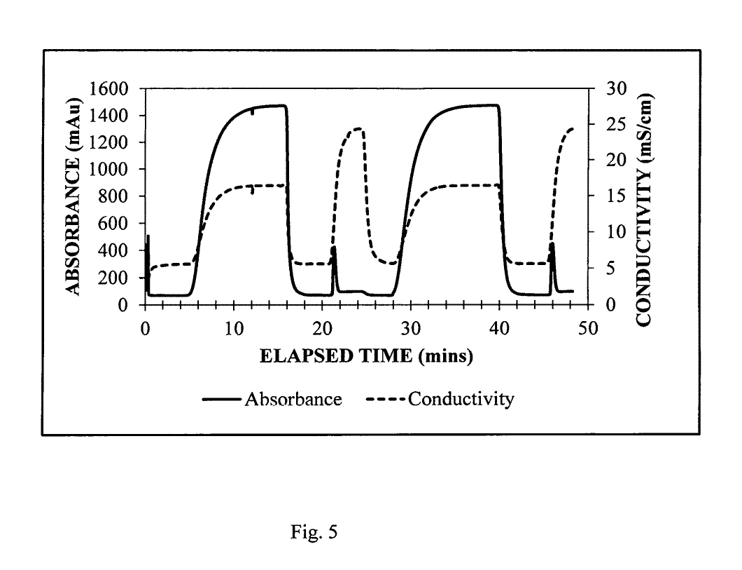

FIG. 6 shows a schematic of process synchronization in One-column Continuous Chromatography (OCC),

FIG. 7 shows reduction in conductivity as a signal of capturing (Protein A) column exhaustion. Black arrow shows the conductivity in a functioning Protein A column and the dashed arrow shows the conductivity in an exhausted Protein A column after 100 cycles of operation.

FIG. 8 HCP content at the end of a typical perfusion run (Day 34 sample). The authors assumed this would constitute the day with highest HCP content accumulated over entire run.

### DETAILED DESCRIPTION OF THE INVENTION

The alternative tangential flow perfusion bioreactor was operated without cell bleeding under metabolic control. Perfusion culturing of cells has its conventional meaning in the art, i.e. it means that during culturing cells are retained by a filter module in which there is an outflow of liquid void of cells “the perfusate”. A person skilled in the art knows how to determine the outflow or perfusion rate. Perfusion culturing results in the production of a continuous flow. Filter modules comprising tubular membranes are commercially available from for example Spectrum Laboratories (SpectrumLabs). With “alternating tangential flow within the filter module” is meant that there is one flow in the same direction as (i.e. tangential to) the membrane surfaces of the hollow fibers, which flow is going back and forth, and that there is another flow in a direction substantially perpendicular to said filter surface. Tangential flow can be achieved according to methods known to the person skilled in the art. For example, in U.S. Pat. No. 6,544,424 it is described that alternating tangential flow can be achieved using one pump to circulate the cell culture over a filter module comprising hollow fibers and another pump to remove the liquid having a lower cell density than prior to the filter separation. In the process of the present invention, the separation device is a filter module comprising hollow fibers. With the term “hollow fiber” is meant a tubular membrane. Preferably, the mesh size in the membrane is chosen such that the size of the pores in the mesh is close to the diameter of the cells, ensuring a high retention of cells while cell debris can pass the filter. Preferably, the mesh size is between 0.2 and 30 microns. Cells which can be used to produce the biological substance are in principle all cells known to the person skilled in the art, which have the ability to produce a biological product. Preferably, the cells that are used in the process of the present invention are animal cells, in particular mammalian cells. Examples of mammalian cells include CHO (Chinese Hamster Ovary) cells, hybridomas, MDCK (Madin Derby Canine Kidney) cells, myeloma cells, human cells, for example HEK-293 cells, HeLa cells, human lymphoblastoid cells, E1 immortalized HER cells and PER.C6 cells. CHO cells have a diameter of approximately 13 microns, HEK cells a diameter of 15 microns and HeLa cells of 20 microns (Milo et al., 2010). In yet another embodiment of the invention, a biological substance is produced by the cells. The biological substances that can suitably be produced in the perfusion culturing of the cell are in principle all biological substances that can be produced by animal, especially mammalian, and yeast cells, for example therapeutic and diagnostic proteins, such as monoclonal antibodies, growth factors or peptide hormones, enzymes, polynucleotides, live viruses and genetically-engineered viral vectors (viral particles) used in gene therapy, recombinant proteins used in vaccines, etc.

According to the process of the invention, a high viable cell density is a density of at least 40.times.10.sup.6 cells per mL, preferably at least 50.times.10.sup.6 cells per mL, more preferably at least 60.times.10.sup.6 cells per mL. Typically, a suitable upper limit in the cell density may lie around 70.times.10.sup.6 cells per mL.

Surprisingly, the extremely high cell density of the process of the invention is accompanied by a high cell viability. A high cell viability is a viability of at least 90%, preferably at least 95%, more preferably at least 97%, most preferably at least 99%.

It is to be understood that high viable cell density and high cell viability are reached after a certain period of perfusion culturing, generally when the cells have reached a steady state, for mammalian cells typically 12 to 25 days after the initiation of perfusion culturing.

The pH, temperature, dissolved oxygen concentration and osmolarity of the cell culture medium are in principle not critical and depend on the type of cell chosen. Preferably, the pH, temperature, dissolved oxygen concentration and osmolarity are chosen such that it is optimal for the growth and productivity of the cells. Usually, the optimal pH is between 6.8 and 7.2, the optimal temperature between 32 and 39.degree. C., the optimal osmolarity between 260 and 400 mOsm/kg.

Generally, a cell culture medium for mammalian cells comprises amino acids, vitamins, lipids, salts, detergents, buffers, growth factors, hormones, cytokines, trace elements and carbohydrates. Examples of amino acids are all 20 known proteinogenic amino acids, for example histidine, glutamine, threonine, serine, methionine. Examples of vitamins include: ascorbate, biotin, choline.Cl, myo-inositol, D-panthothenate, riboflavin. Examples of lipids include fatty acids, for example linoleic acid and oleic acid; soy peptone and ethanol amine. Examples of salts include magnesium salts, for example MgCl.sub.2.6H.sub.20, MgSO.sub.4 and MgSO.sub.4.7H.sub.20 iron salts, for example FeSO.sub.4.7H.sub.20, potassium salts, for example KH.sub.2PO.sub.4, KCl; sodium salts, for example NaH.sub.2PO.sub.4, Na.sub.2HPO.sub.4 and calcium salts, for example CaCl.sub.2.2H.sub.20. Examples of detergents include Tween 80 and Pluronic F68. An example of a buffer is HEPES. Examples of growth factors/hormones/cytokines include IGF, hydrocortisone and (recombinant) insulin. Examples of trace elements are known to the person skilled in the art and include Zn, Mg and Se. Examples of carbohydrates include glucose, fructose, galactose and pyruvate.

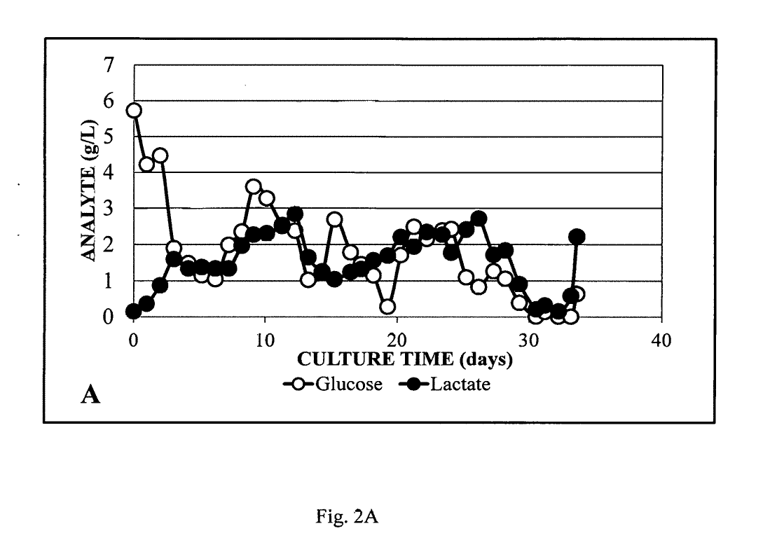

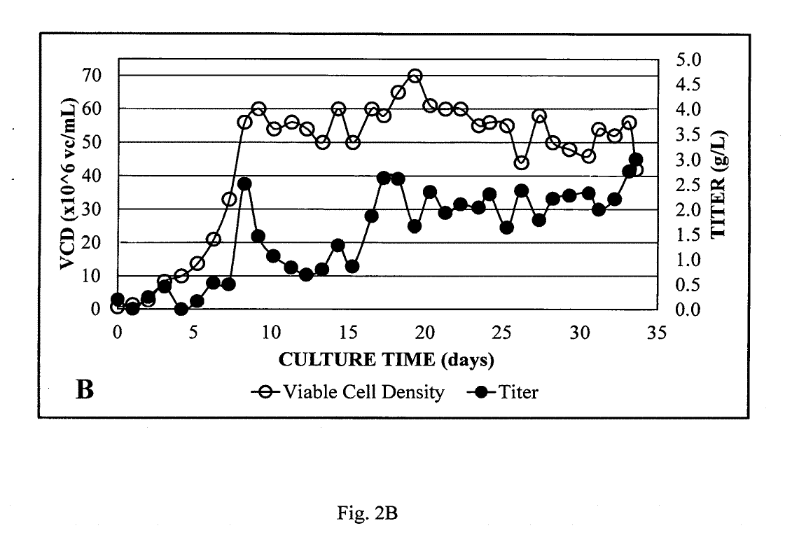

In one embodiment, metabolic control allows high cell viability greater than 95% and high cell density under steady state conditions in the range of 40.times.10.sup.6 to 70.times.10.sup.6 cells/ml by using low perfusion flow rates of one vessel volume per day (vvd) or less. Metabolic control is obtained by the addition of key nutrients such as glucose and glutamine and the removal of key toxic metabolites such as lactate and ammonia, metabolites affect the viability and viable cell density of the perfusion cell culture. The monitoring of metabolites such as glucose and glutamine can be obtained in real time by the use of biosensors in flow injection analysis (FIA) mode. (Cattaneo et al, 1992; Cattaneo et al, 1993). Metabolic control promotes high cell viabilities under low perfusion conditions approaching one bioreactor vessel volume per day (vvd), perfusion conditions which would normally result in low cell viabilities and low cell viable cell densities. High cell viabilities are necessary to maintain high cell productivity and to minimize cell death which results in cell debris which causes the perfusion filter to clog, as described in U.S. Pat. No. 6,544,424. It was surprisingly found that perfusing at low 1 vvd while controlling the level of glucose between 1 g/L and 3 g/L and the lactate levels below 3 g/l (FIG. 2A) with an antibody-producing CHO-K1 cell line with the Glutamine Synthetase selection system resulted in viable cell densities between 40.times.10.sup.6 and 70.times.10.sup6 and cell viabilities exceeding 96% perfusion and antibodies titers of 2-3 g/l for over 20 days of continuous production starting at day 10 (FIG. 2B).

Preferably, the process according to the invention is used for the production of a biopharmaceutical product, which is a biological substance with a medical application. Examples of biopharmaceutical products are as follows (with examples of brand names of the corresponding biopharmaceutical product between brackets): Adalimumab (Humira™), Bevacizumab (Avastin™) (recombinant) antihemophilic factor (ReFacto™) lymphoblastoid Interferon .alpha.-n1 (Wellferon™), (recombinant) Coagulation factor (NovoSeven™), Etanercept, (Enbrel™), Trastuzumab (Herceptin™), Infliximab (Remicade™), Basiliximab (Simulect™), Daclizumab (Zenapaz™), (recombinant) Coagulation factor IX (Benefix™), erythropoietin alpha (Epogen®), G-CSF (Neupogen® Filgrastim), Interferon alpha-2b (Infergen®), recombinant insulin (Humulin®), Interferon beta 1a (Avonex®), Factor VIII (KoGENate®), Glucocerebrosidase (Cerezyme™), Interferon beta 1b (Betaseron®), TNF alpha receptor (Enbrel®), Follicle stimulating hormone (Gonal-F®), Palivizumab (Synagis®, ReoPro®), Rituximab (Rituxan®), tissue plasminogen activator (Activase®, Actilyase®), human growth hormone (Protropin®, Norditropin®, GenoTropin™). Examples of polynucleotides with a possible medical application are gene therapeutic plasmid DNAs. Examples of vaccines are live, oral, tetravalent Rotavirus vaccine (RotaShield™), rabies vaccine (RanAvert™) Viral vectors are presently tested in clinical trials for their medical application in restoring genetic defects.

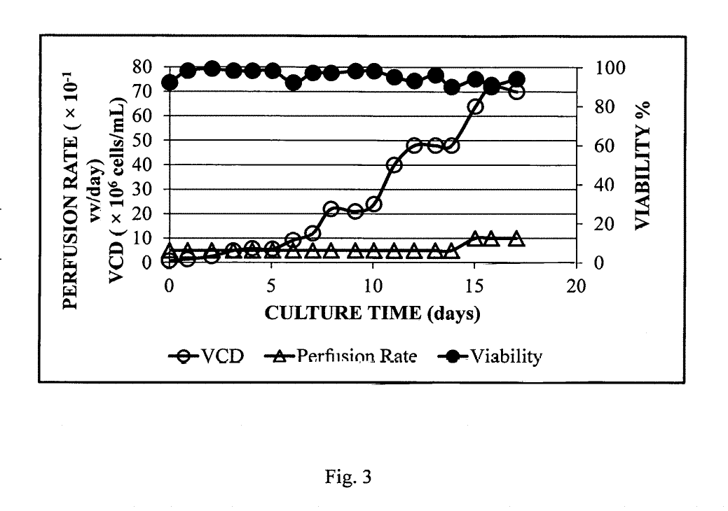

In one preferred embodiment a therapeutic MAb was produced from CHO-K1 cells under perfusion in a 2 L bioreactor for 35 days. The growth profile and perfusion rate values are shown in FIG. 3. As mentioned earlier, media optimization techniques allowed for maintaining perfusion rates at one vessel volume/day on average throughout the run. Critical nutrient and wastes control over the run are also shown in FIG. 3. By carefully controlling media components, the levels of critical nutrients in the bioreactor were kept at adequate levels. This tight control of nutrients ensured production of material within acceptable product quality requirements.

For the production phase of the cell culture metabolic control based on glucose levels to maintain the cell density between 40 million cell/ml and 60 million cells/ml while keeping the perfusion rate constant at 1 vessel volume per day was employed throughout the 35-day run. As shown in FIG. 2A, the growth phase of the cell culture which lasted 10 days using 1 vvd perfusion rate achieved cell densities of 60 million cells/ml. On day 15 after seeding the bioreactor we reduced the level of glucose from 3 g/L down to 0 g/L to limit cell growth to around 60 million cells/mL, which occurred on day 20 as shown in FIG. 2B. Additionally, this metabolic control strategy can also be applied by controlling concentration of other essential nutrients such as glutamine, other amino acids, growth factors, etc. alone or in combination, while keeping the perfusion rate constant at 1 vvd (vessel volume per day).

This novel approach, which aims to control stable, optimal cell density and protein production through metabolic control, eliminates the need for repetitively removing cells from the bioreactor (i.e. bleeding). Regular bleeding of the bioreactor in continuous manufacturing is a standard required protocol and a well known high risk factor for microbial contamination, which is the main cause of failed bioreactor runs. Thus, by applying metabolic control through addition and/or removal of key nutrient(s) to keep cell densities and viability at ideal values for protein production bleeding is no longer necessary.

The biological substance in the outflow of the perfusion filter may be further purified in so-called downstream processing. Downstream processing usually comprises several purification steps in varying combinations and order. Examples of purification steps in the downstream processing are separation steps (e.g. by affinity chromatography or hydrophobic interaction chromatography), steps for the concentration of the biological substance (e.g. by ultrafiltration or diafiltration), steps to exchange buffers and/or steps to remove viruses (e.g. by virus filtration and/or pH shift).

An additional benefit of using metabolite control to limit the perfusion rate to 1 vvd or less is the ability to load the perfusate directly onto a single chromatography capture column. Multiple column chromatography systems such as simulated moving beds (SMB), periodic counter current chromatography (PCC) and two column chromatography (TCC) can be replaced by the one-column continuous chromatography (OCC) system described herein because of the low perfusate flow coming from the perfusion bioreactor. The bind/elute cycle of the OCC can be synchronized to the perfusion rate exiting the perfusion filter.

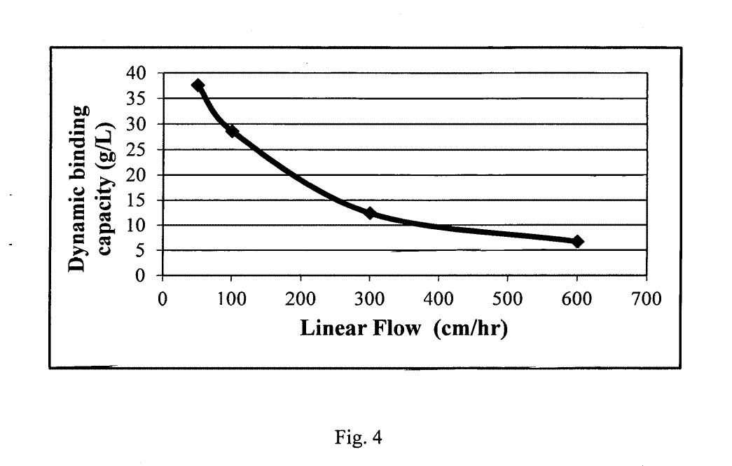

In one preferred embodiment the low flow of the perfusate of 1 vvd corresponds to a flow velocity of 100 cm/hour or a residence time of 1 minute or less for a 5 ml column results in high dynamic binding capacities approaching 40 g of antibody per liter of protein A resin as shown in FIG. 4. By running at low rates of perfusion the dynamic binding capacity of the protein A column is significantly increased compared to a high-flow condition typical of batch operations, where dynamic binding capacities of 10 g of antibody per liter are common.

The lower the flow of the perfusate (conditioned or spent media that contains the desired secreted protein product such as an antibody), the higher the dynamic binding capacity of the capture column such as Protein A for capturing antibodies or HIC (Hydrophobic Interaction Column) for capturing recombinant proteins. By using low perfusate flows such as one vessel volume per day or less (0.5-1 vvd) we obtain a high dynamic binding capacity and therefore we maximize the utilization of the capture column such as Protein A or HIC per cycle.

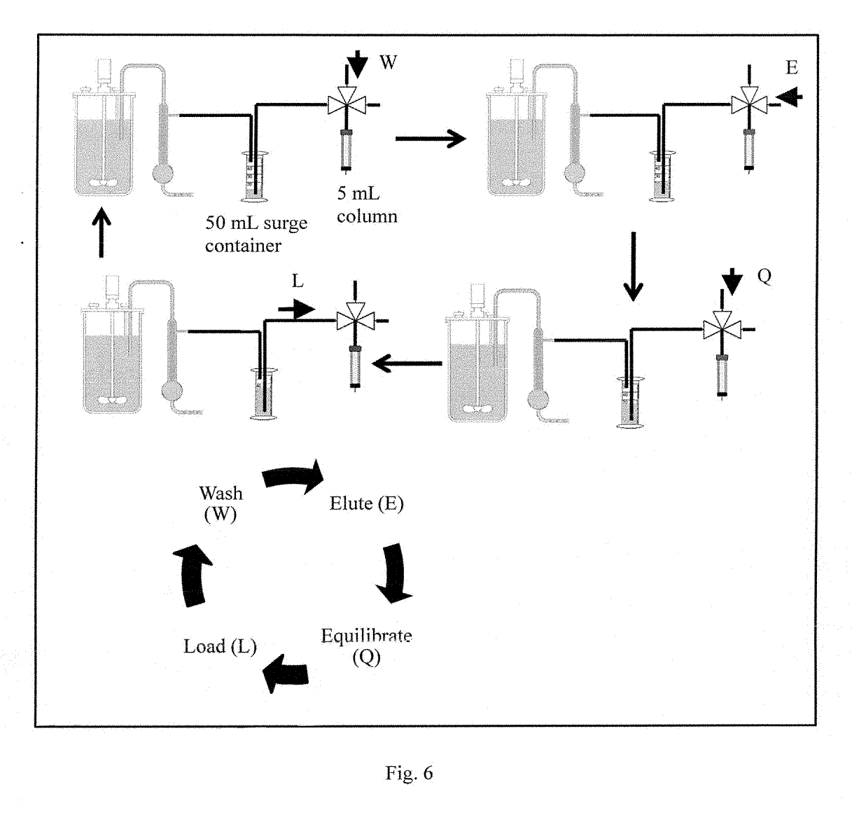

In one preferred embodiment, the synchronization between upstream and downstream was performed using a single Protein A column for capture of monoclonal antibodies. This one column system was preferred because of its simplicity and ease of implementation especially in manufacturing environments. Compared to other approaches developed so far, no new hardware or software will have to be developed to implement this new platform process. Column operations were optimized to ensure that the total time for a single cycle was equivalent to the rate of production of perfusate from the reactor. As shown in FIG. 6, purification begins with about 20 mL perfusate in the holding bottle. The cycle begins at the end of a load (L) cycle and a beginning of the wash (W) cycle. The wash cycle is done with 10 column volumes for 5 mins (7 mL collected in holding bottle). After wash is clution with 5 column volumes for 5 mins (14 mL total perfusate collected). The equilibration step takes another 10 column volumes for 5 more minutes (21 mL total collected in holding bottle). The load step takes 9 mins to load 35 mL of perfusate (12.6+21 mL=33.6 mL total collected). The excess load over perfused is compensated for during the three 20 mins sanitization steps that occur once every 20 cycles.

A very important aspect of the current approach is the column switching strategy. Prepacked MabSelect columns (GE Corporation) are usually rated to two hundred cycles. However, there has to be a rigorous monitoring technique designed to detect and even predict when the protein A column begins to fail. In the current OCC approach, upstream and downstream synchronization is so tightly controlled, that traditional pulse testing approaches are not practical. To achieve column monitoring, a real-time transition analysis of spectral data of each cycle was performed to provide an HETP value using a modified Larson approach (Larson et al. 2003). The OCC approach therefore makes column monitoring very practical despite existing infrastructure and reduces the number of failure modes. For instance with a different continuous chromatography approach such as simulated moving beds (SMB), monitoring all six columns remains very cumbersome and the failure of any one of the columns will result in a disruption in the process in order to execute a replacement.

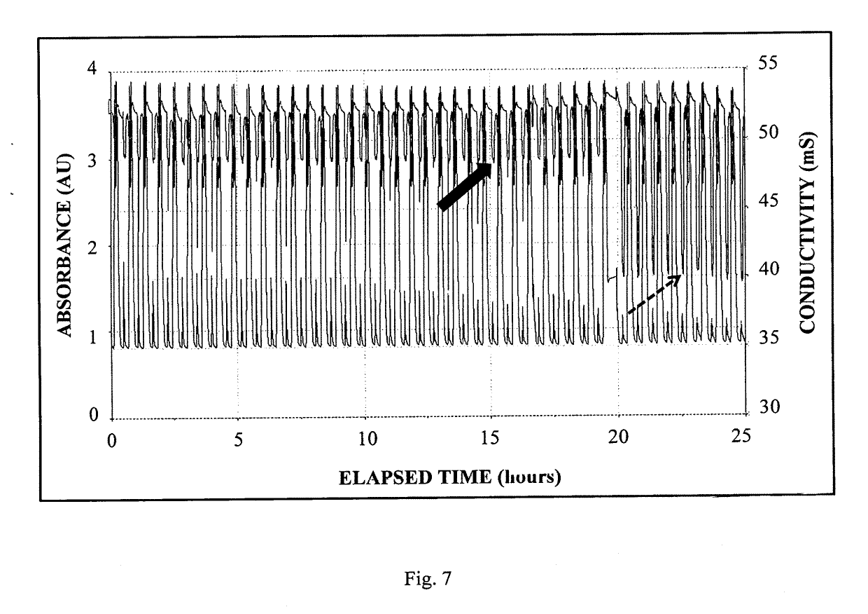

In another embodiment the last twenty four hours prior to column failure. FIG. 7 shows that by visual observation, the column failed at around 160 cycles (72 hrs including sanitization/regeneration steps), however, from the modified Larson approach, the column failure was predicted about 20 cycles earlier (64 hrs). The conductivity of the Protein A column drops from around 48 mS down to 40 mS on day 20 after seeding the bioreactor. A reduction in conductivity of 20%±5% is an indicator of the exhaustion of the protein capture column and a signal that it needs to be replaced with a new column to continue operations in an uninterrupted manner. This distinct signal allows the repetitive use of a much smaller column compared to batch operation where larger diameter columns are required to satisfy the much larger spent media production flows. The use of many smaller columns reduces the quantity of protein capture resin by an order of magnitude or more compared to a batch process.

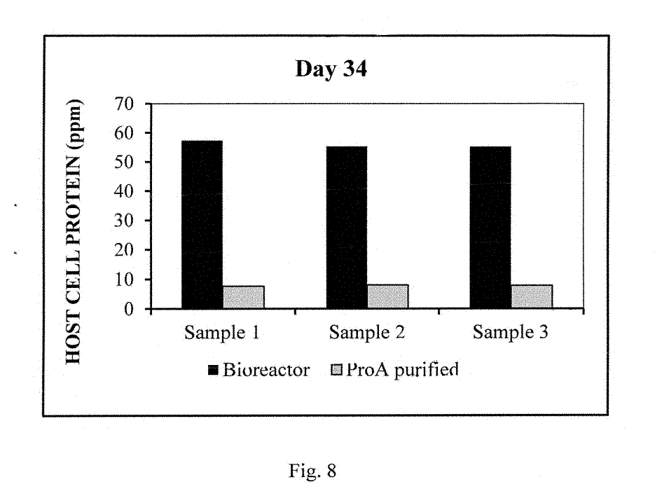

As shown in FIG. 8 another important advantage of the continuous bioprocess outlined in this invention is the very low level of host cell protein (HCP) in the bioreactor and purified material. Since the bioreactor is operating under perfusion, which averts accumulation, there are already low levels of HCP in the perfusate. Moreover, affinity chromatography is an excellent method for eliminating the bulk HCP from the perfusate (Hogwood et al. 2013; Nian et al. 2016). In this approach, triplicate samples from the bioreactor and from the purified product were taken and analyze for HCP content. FIG. 8 shows a fifty fold lower HCP content than acceptable. The industry HCP content typically allowed in antibody products is 100 ppm (Champion et al. 2001; Wang et al. 2009). Thus even after concentrating the protein A purified material by five-fold for next step purification, the HCP concentration will still be at allowable limits. This makes the current approach and excellent candidate for human studies.

### Example 1

Perfusion mode cell culture using was conducted on bioreactors with 2 L working volume using an ATF2 system equipped with a 0.2 μm hollow fiber filter. Dissolved oxygen was controlled using O₂ gas via a sintered sparger. Cell density (Life Technologies, Grand Island, N.Y.), nutrients and waste were monitored by offline measurements. Chemically defined media was modified via internal experiments to optimize bioreactor performance and proprietary CHO cell lines producing biosimilars were used. The cells were seeded at 0.5 million cells/mL. Cell growth and waste were controlled by perfusion rate and nutrients were controlled by media optimization. The process was optimized to an average perfusion rate of one reactor volume/day. pH was controlled around 7.2 with sodium bicarbonate and CO₂ gas. DO was kept above 40%. The harvest was loaded directly onto a single Protein A column without additional clarification.

Using the 2 L bioreactor, the perfusion rate was optimized during the antibody production phase to 1 vv/day corresponding to 2000 mL of spent media every 24 hours. A single column operation was optimized to 24 minutes with a 35 mL load of perfusate per cycle. A 20 minute cleaning/sanitization cycle was conducted after every 20 cycles. This results in 60 complete cycles every 24 hours or 2000 mL every 24 hours, equivalent to the perfusion rate. The synchronization of perfusion rates and antibody capture rates while maintaining glucose and lactate levels at desired rates was thus achieved.

Titer was quantified using ELISA. Mouse anti-human capture IgG (100 μL per well) was used to coat a flat bottom 96-well plate overnight at 4° C. The wells were washed three times with 200 μL of washing buffer. The plate was blocked with 200 μL of blocking buffer at 37° C. for 1 hour and washed three times with 200 μL of washing buffer. To each well was added 100 of standards, samples and control with corresponding dilutions and the plate was incubated at room temperature for 1 hr. The samples were washed three times with 200 μL of washing buffer and 100 pt of the secondary antibody was added and incubated at 37° C. for an additional 0.5 hrs. The plates were washed three times with 200 μL of washing buffer and 100 μL of Tetramethylbenzidine (TMB) solution was added. Plate was incubated for about 5 to 15 minutes at room temperature and developed blue color was read at 655 nm.

Host cell protein in the bioreactor sample and purified sample was quantified by ELISA using commercial kits (Cygnus Technologies, Plainville, Mass.). The standard provided by the manufacturer was used to build the calibration curve between 2 and 100 ng/mL.

A single Protein A cycle involves an equilibration, a load, a wash and an elution step. The OCC approach is summarized in FIG. 6. While the wash, elute and equilibration steps are progressing, enough perfusate for a single chromatographic cycle load step accumulates in the holding surge container. Actually, a slightly smaller amount than that perfused is loaded to account for the accumulation that occurs during the sanitization/regeneration steps that are performed after 20 cycles. The amount of material in the surge container can be minimized to near zero.

The unique feature of this approach is the perfect synchronization with the perfusion rate upstream. A single chromatographic cycle was optimized to 24 minutes with the flow rate for loading only half of those for the other steps. The low loading flow rates increased dynamic binding capacities to levels very close to the static binding capacities, a feature that will be very useful as upstream future process optimizations for perfusion cell cultures enhances antibody productivity.

Antibody capture was done with a 5 mL prepacked MabSelect column (GE Healthcare, Pittsburgh, Pa.) connected to a Quantasep1000 unit (Sepragen, Hayward, Calif.). Each column operation consisted of an equilibration, a load, a wash, an elute and a regeneration step. Although the unit did not provide a sterile operation, there are readily available newer units with the same specifications that offer complete single use flow lines which can be used during GMP manufacturing.

In this example, the first successful attempt at using a one-column continuous chromatography (OCC) for the continuous capture of therapeutic antibodies produced through ATF perfusion is presented. A 3 L perfusion reactor was used in combination with a single 5 mL prepacked Protein A column for the continuous capture of a therapeutic antibody. The upstream ATF perfusion was optimized to one reactor volume/day. The media was also optimized for excellent product quality. A prepacked Protein-A column, less than 1% the size of the bioreactor was used to continuously capture perfused antibody under low flow rates. The column was switched after 120-140 cycles. This approach is the first and only attempt at using a single column for the implementation of a truly integrated continuous biomanufacturing platform. This approach offers a cost effective and flexible platform process for the manufacture of both stable and unstable therapeutic agents. A proof of Concept perfusion mode cell culture was conducted on pilot bioreactors with 2 L working volume using an ATF2 system equipped with a 0.2 μm hollow fiber filter.

Dissolved oxygen was controlled using O₂ gas via a sintered sparger. Cell density (Life Technologies, Grand Island, N.Y.), nutrients and waste were monitored by offline measurements. Chemically defined media was modified via internal experiments to optimize bioreactor performance and proprietary CHO cell lines producing biosimilars were used. The cells were seeded at 0.5 million cells/ml. Cell growth and waste were controlled by perfusion rate and nutrients were controlled by media optimization. The process was optimized to an average perfusion rate of one reactor volume/day. pH was controlled around 6.8-7.2 with sodium bicarbonate and CO₂ gas. DO was kept above 40%. The harvest was loaded directly onto a single Protein A column without additional clarification.

The continuous process includes a bioreactor for growing mammalian cells which produce recombinant proteins, monoclonal antibody or viral vectors, a perfusion filter operated in alternating tangential flow and a capture column for binding the product.

The Mass Flow Controller (MFC) controlled the perfusate and feed flows in and out of the bioreactor. Dissolved oxygen was controlled by the MFC using an O2 gas sparger. Carbon dioxide gas and sodium bicarbonate was used to control pH. Cell density, nutrients and waste metabolites were monitored by offline measurements. Chemically defined, serum-free media was modified via internal experiments to optimize bioreactor performance and proprietary CHO cell lines producing monoclonal antibodies were used.

The cells were seeded at 0.5 million cells/ml. Cell growth and waste were controlled by adjusting perfusion rate, and nutrients were controlled by media optimization as shown in FIG. 2B. The process was optimized to an average perfusion rate of one reactor volume/day. pH was controlled around 7.2 with sodium bicarbonate and CO2 gas. DO was kept above 40%. The perfusate was loaded directly onto a single Protein A column without additional clarification.

The perfusion rate was monitored in real time and was controlled to maintain a stable high cell density, viability and protein production in the bioreactor. After the “growth phase” started which occurred on day 10 after seeding the bioreactor, we switched to the “production phase” when the cells produce and secrete high levels of protein such as antibodies used in therapies or viral proteins used in vaccines. The growth phase typically uses a nutrient rich media such as CD-CHO (Chemically Defined, serum-free media especially designed for suspension CHO cell growth).

It was surprising that if the cell viability fell below 95% this had a detrimental impact on the perfusion filter due to cell debris plugging the filter pores, thereby preventing the free flow of perfusate through the perfusion filter. The perfusion rate had to be increased from 1 vvd to 2 vvd to keep the cell viability above 95% as shown in FIG. 3.

The Perfusion mode cell culture was conducted on bioreactors with 2 L working volume using an ATF2 system (Refinetech) equipped with a 0.2 micron hollow fiber perfusion filter to retain the cells in the bioreactor. The produced, secreted protein such as an antibody passes through the filter and goes directly into the protein capture column with no harvesting step in between. Harvesting is now considered a major bottleneck to biomanufacturing. Good harvesting filters that can process large amounts of spent media are not readily available.

By avoiding the harvesting step the amount of cell debris, which includes residual host cell protein (HCP) and DNA, is now greatly reduced. The HCP levels were found to be below 10 ppm. The level of cell debris significantly affects the lifespan of the protein capture column downstream, high levels reducing the number of possible purification cycles of the protein capture column. It is standard practice in a batch operation to recycle the Protein A column about 4 times per day. However, by maintaining cell viability at about 95%, as many as 200 recycle times for a single Protein A column were achieved.

Our continuous manufacturing system produces impurities in low amounts such as Host Cell Protein (HCP<10 ppm) compared to a Fed-Batch process where the HCP exceeds 1000 ppm. In the case of a batch operation, which includes a harvesting step, the cell debris in the harvest is inherently much higher because there is considerable shear (HCP>1,000 ppm). The higher content of cell debris causes accelerated plugging of the protein capture column, thus reducing the number of capture column cycles that can be obtained with the column. We have been able to increase the number of column cycles from 50 to 200 cycles. A complete protein capture column cycle consisted of an equilibration, a load, a wash, an elute and a regeneration step.

Low flow antibody capture was done with a 5 mL prepacked MabSelect column (GE Healthcare) connected to a Quantasep1000 unit (Sepragen, Hayward, Calif.).

Antibody capture was done with a 5 mL prepacked MabSelect column (GE Healthcare) connected to a Quantasep1000 unit (Sepragen, Hayward, Calif.). Each column operation consisted of an equilibration, a load, a wash, an elute and a regeneration step. A cleaning/sanitization step was done every 20 cycles and a new column was installed after every 200 cycles. Although the unit did not provide a sterile operation, there are readily available newer units with the same specifications that offer complete single use flow lines which can be used during GMP manufacturing.

### REFERENCES

Cattaneo et al. (1992). “Monitoring glutamine in mammalian cell cultures using an amperometric biosensor.” Biosens Bioelectron 7(5):329-34.
Cattaneo and Luong (1993) “Monitoring glutamine in animal cell cultures using a chemiluminescence fiber optic biosensor”. Biotech Bioeng 03, 41(6):659-65.
Aldington S and Bonnerjea J. (2007). “Scale-up of monoclonal antibody purification processes.” J Chromatogr B Analyt Technol Biomed Life Sci 848(1): 64-78.
Angarita M, Muller-Spath T, Baur D, Lievrouw R, Lissens G and Morbidelli M. (2015). “Twin-column Capture SMB: a novel cyclic process for protein A affinity chromatography.” J Chromatogr A 1389: 85-95.
Birch J R and Racher A J. (2006). “Antibody production.” Adv Drug Deliv Rev 58(5-6): 671-85.
Champion K M, Nishihara J C, Joly J C and Arnott D. (2001). “Similarity of the Escherichia coli proteome upon completion of different biopharmaceutical fermentation processes.” Proteomics 1(9): 1133-1148.
Girard V, Hilbold N J, Ng C K, Pegon L, Chahim W, Rousset F and Monchois V. (2015). “Large-scale monoclonal antibody purification by continuous chromatography. from process design to scale-up.” J Biotechnol 213: 65-73.
Hober S, Nord K and Linhult M. (2007). “Protein A chromatography for antibody purification.” J Chromatogr B Analyt Technol Biomed Life Sci 848(1): 40-7.
Hogwood C E, Tait A S, Koloteva-Levine N, Bracewell D G and Smales C M. (2013). “The dynamics of the CHO host cell protein profile during clarification and protein A capture in a platform antibody purification process.” Biotechnol Bioeng 110(1): 240-51.
Keβler L C, Gueorguieva L, Rinas U and Seidel-Morgenstern A. (2007). “Step gradients in 3-zone simulated moving bed chromatography. Application to the purification of antibodies and bone morphogenetic protein-2.” J Chromatogr A 1176(1-2): 69-78.
Konstantinov K B and Cooney C L. (2015). “White paper on continuous bioprocessing. May 20-21, 2014 Continuous Manufacturing Symposium.” J Pharm Sci 104(3): 813-20.
Larson T M, Davis J, Lam H and Cacia J. (2003). “Use of process data to assess chromatographic performance in production-scale protein purification columns.” Biotechnology Progress 19(2): 485-492.
Milo et al., (2010) Nucl. Acids Res 38, suppl 1: D750-D753 Natarajan V and Zydney A L. 2013. “Protein A chromatography at high titers.” Biotechnol Bioeng 110(9): 2445-51.
Ng C K S, Rousset F, Valery E, Bracewell D G and Sorensen E. (2014). “Design of high productivity sequential multi-column chromatography for antibody capture.” Food and Bioproducts Processing 92(2): 233-241.
Nian R, Zhang W, Tan L, Lee J, Bi X, Yang Y, Gan H T and Gagnon P. (2016) “Advance chromatin extraction improves capture performance of protein A affinity chromatography.” J Chromatogr A 1431: 1-7.
Pollock J, Ho S V and Farid S S. (2013). “Fed-batch and perfusion culture processes: economic, environmental, and operational feasibility under uncertainty.” Biotechnol Bioeng 110(1): 206-19.
Schaber S D, Gerogiorgis D I, Ramachandran R, Evans J M B, Barton P I and Trout B L. (2011). “Economic analysis of integrated continuous and batch pharmaceutical manufacturing: A case study.” Industrial & Engineering Chemistry Research 50(17): 10083-10092.
Walther J, Godawat R, Hwang C, Abe Y, Sinclair A and Konstantinov K. (2015). “The business impact of an integrated continuous biomanufacturing platform for recombinant protein production.” J Biotechnol 213: 3-12.
Wang X, Hunter A and Mozier N M. (2009). “Host cell proteins in biologics development: Identification, quantitation and risk assessment.” Biotechnol Bioeng 103(3): 446-458.
Warikoo V, Godawat R, Brower K, Jain S, Cummings D, Simons E, Johnson T, Walther J, Yu M, Wright B, McLarty J, Karey K P, Hwang C, Zhou W, Riske F and Konstantinov K. (2012). “Integrated continuous production of recombinant therapeutic proteins.” Biotechnol Bioeng 109(12): 3018-29.
Xenopoulos A. (2015). “A new, integrated, continuous purification process template for monoclonal antibodies: Process modeling and cost of goods studies.” J Biotechnol 213: 42-53.
Zydney A L. (2015). “Perspectives on integrated continuous bioprocessing—opportunities and challenges.” Current Opinion in Chemical Engineering 10: 8-13
Jordan, et al. (1992). “Tuning of shear sensitivity of CHO cells and its correlation with the size distribution of cell aggregates”. Animal cell technology: developments, processes and products, eds. Spier, R. E., Griffiths, J. B. and MacDonald, C. London: Butteworth-Heinemann, pp. 418-420. cited by applicant.
Shevitz, et al. (1989). “Stirred tank perfusion reactors for cell propagation and monoclonal antibody production” in “Advances in Biotechnological Processes”. Furey, J. (2002). Genetic Engineering News 22(7): 62-63. cited by applicant.
Filet, and Cooney. (1990). “Mammalian cell and protein distributions in ultrafiltration hollow fiber bioreactors.” Biotechnology and bioengineering, 36:902-910. cited by applicant.
Xie, et al. (2002). Biotechnology and Bioengineering. 80(5): 569-579. cited by applicant. Horwath. (1995). “Facility Design and Validation Considerations for Continuous Cell Culture Processes.” Animal Cell Technology: Developments Towards the 21st Century, Springer, eds. Reuvery, et al., p. 553-559. cited by applicant.
Norris, et al., (2002). “Growth of Cell Lines in Bioreactors,” Basic Methods in Antibody Production and Characterization, CRC Press, eds. Howard, et al., pp. 87-103. cited by applicant.
Furey, J., “Continuous cell culture using the ATF system”, (2000). Genetic Engineering News 20(10, 15), 52-53 cited by applicant.
Voisard, D., et al. (2003). “Potential of cell retention techniques for large-scale high-density perfusion culture of suspended mammalian cells.” Biotechnology and Bioengineering. 82(7) 751-765. cited by applicant.
Woodside S. M. et al. (1998). “Mammalian cell retention devices for stirred perfusion bioreactors” Cytotechnology 28 (1-3) 163-175. cited by applicant.
Banik, et al. (1995). “Partial and total cell retention in a filtration-based homogeneous perfusion reactor.” Biotechnology Prog. 11, pp. 584-588. cited by applicant John R. W. Masters (2000). “Animal Cell Culture: A Practical Approach, Oxford University Press, 2000 (“Masters (2000)”); p. 59. cited by applicant.
Shevitz et al. (1989). “Stirred tank perfusion reactors for cell propagation and monoclonal antibody production.” in “Monoclonal antibodies: Production and Application” Advances in Biotechnological Processes, 11:81-106. cited by applicant.

We claim:

1. A method for producing a therapeutic or other antibody of interest in a serum-free, chemically defined continuous mammalian cell culture, said method comprising (a) culturing mammalian cells expressing the antibody of interest in a perfusion cell culture system, wherein said cells are cultured in a serum-free, chemically defined medium and wherein said cell culture system comprises a cell retention device (e.g. hollow fibers) with pore size greater than 0.2 microns and a perfusion rate (R) of less than or equal to 1 vessel volume per day (vvd) and (b) recovering said antibody of interest from the perfusion vessel continuously by affinity capture column chromatography with a single column that has affinity resin amount that is less than 0.1-5% of the volume of the bioreactor.

2. The method of claim 1, wherein said cell retention device has a pore size of greater than 0.1 microns and less than 10 microns.

3. The method of claim 1, wherein said perfusion rate is more than 0.5 vvd and less than 2 vvd.

4. The method of claim 1, wherein said cell density is greater than 40.times.10.sup.6 viable animal cells/ml and less than 70.times.10.sup.6 viable animal cells/ml

5. The method of claim 1, wherein said cells are cultured in said cell culture system for more than 20 days.

6. The method of claim 1, wherein said cells are cultured in said cell culture system for more than 30 days.

7. The method of claim 1, wherein glucose levels in the culture vessel are maintained between 0.1 g/L and 3 g/L and lactate levels are maintained below 3 g/L.

8. The method of claim 1, wherein said cells are CHO, Per.C6 or HEK cells.

9. The method of claim 1, wherein said recovery occurs in a single affinity column.

10. The method of claim 10, wherein said single column contains affinity resin greater than 0.1% and less than 5% the volume of the bioreactor.

11. The method of claim 10, wherein the rate of purification is greater than 50% and less than or equal to 100% the rate of perfusion.

12. The method in claim 1, wherein a surge vessel of less than or equal to 100% the volume of the reactor exists between the reactor and the purification system.

13. A method for synchronizing the perfusion flow rate from the bioreactor with the bind/elute cycle of the downstream chromatography system by feeding back the downstream chromatography signals including UV absorbance and conductivity signals into a control system that will control the upstream perfusate and bioreactor feed mass flow rates.

14. The method in claim 13 which provides a stable, optimal cell density between 40 million cells per mL and 70 million cells per mL, by using metabolic control thus eliminating the need to repetitively remove cells (i.e. bleeding) from the bioreactor.

15. The method in claim 13, wherein the cell viability in the bioreactor is maintained at or above 95% by metabolic control which results in a much reduced cell debris and results in an increase in the lifespan of both the upstream perfusion filter and the downstream capture column.

16. The method in claim 13 where a 5% reduction in baseline UV absorbance reading following the appearance of the product peak triggers a switch from bind to elution mode during a purification cycle.

17. The method in claim 13 wherein a drop in conductivity of 20% or greater triggers an alarm signal warning the operator to replace the chromatography column or automatically replaces the capture column with a new column in a continuous fashion.

18. A method for reducing the perfusate flow and flow velocity to less than 100 cm/hr resulting in an increase in the dynamic binding capacity of the resin and a reduction in the quantity of required capture resin.
